(19) United States
(12) Patent Application Publication
(10) Pub. No.: US 2022/0028232 A1
(43) Pub. Date: Jan. 27, 2022

(54) METHOD AND SYSTEM FOR MONITORING PORTABLE ARTICLES

(71) Applicant: Se-Kure Controls, Inc., Franklin Park, IL (US)

(72) Inventors: David M. Adams, Stone Park, IL (US); James F. Dryden, Hawthorn Woods, IL (US); Laura A. Greenwell, Bristol, WI (US); John V. Mangiameli, Hawthorn Woods, IL (US); David L. Wooden, Northlake, IL (US); Patrick C. Panico, Berwyn, IL (US); John W. Manser, Elgin, IL (US); Jorge L. Meza, Westchester, IL (US)

(21) Appl. No.: 17/383,155

(22) Filed: Jul. 22, 2021

Related U.S. Application Data
(60) Provisional application No. 63/054,899, filed on Jul. 22, 2020.

(51) Int. Cl. G08B 13/14; G08B 25/00; G08B 25/14; G08B 25/10

(52) U.S. Cl. CPC G08B 13/1436; G08B 25/008; G08B 25/10; G08B 25/14; G08B 13/1427

(57) ABSTRACT

A method of, and system for, handling a portable article. The method includes the step of delivering the portable article to a destination site at which the portable article is operatively associated with an alarm assembly. The alarm assembly has an armed state and an unarmed state. With the portable article operatively associated with the alarm assembly at the destination site and the alarm assembly in the armed state, the alarm assembly generates an alarm signal in the event an unauthorized activity with respect to the portable article occurs.

### BACKGROUND OF THE INVENTION

### Field of the Invention

This invention relates to portable articles and, more particularly, to a method and system for monitoring unauthorized tampering therewith at sites to which the portable articles are delivered.

### Background Art

There is a continuously evolving commerce model of home and business delivery with products ranging from inexpensive grocery items to very expensive items, such as sophisticated electronics. A challenge to purveyors across most product categories has been to offer competitive prices with the fastest delivery times. Consumers are in fact often willing to pay more for promptly delivered goods.

It is common to see advertisements for next-day or even same-day delivery. Industries are experimenting with drone delivery to even further reduce delivery times.

This exploding delivery model has led to having very large volumes of delivered items placed at the steps and doors of homes and businesses. To increase efficiency, a large percentage of such deliveries are made without any attempt to contact the receiving individuals at the destination addresses. Instead, email follow-ups, often sent well after packages are dropped off, have been used to confirm deliveries.

As a result, it is common to see one or more packages placed outside at doorsteps of a large percentage of homes in any given neighborhood. Individuals may not be aware that a package has been delivered for several hours, even if they are present at the delivery location. The packages may remain unattended on doorsteps for an entire day, as when persons residing thereat are at work or otherwise occupied away from home. Still further, when persons leave their residence or business for several days, as on vacation, it may not be possible to coordinate package delivery to avoid having unattended packages reside visibly outside for multiple days. To many, the only solution is to engage neighbors to monitor for packages in the absence of the recipient.

Accordingly, this model has led to a growing industry for thieves. Persons can scour a neighborhood, or business development, and rapidly accumulate packages which are visibly placed in front of buildings and which are completely vulnerable to being taken, potentially without any detection.

Cameras offer some degree of protection. However, often it is impossible to identify thieves and/or any vehicle they may use during a theft. Even if identification is made, it is often impractical to pursue thieves over stolen merchandise that is not particularly expensive. Recipients are often afforded the insurance of having the shipping entity send a replacement in the event that the intended recipient identifies a failed delivery.

Containers are currently available which allow packages of certain limited size to be placed therein whereby they can be recovered only by authorized persons, as through the use of an access key or code. This approach is limited in the sense that only a limited size of package can be accommodated and also by the fact that a larger container compromises the aesthetics of the surrounding area, which is particularly undesirable in a residential setting.

To this point, the main safeguard in this model has been the willingness of the shipping entities to provide replacement for stolen articles. As a result, many businesses are suffering significant losses which ultimately reflect in future prices paid by consumers.

However, even if a consumer is “made whole” by a replacement, the growing culture of thievery tends to taint the overall security of residential and business neighborhoods and continues the upward thievery trend.

The industry continues to seek viable solutions to the above problems which are practical, reasonably inexpensive, and effective in terms of eliminating a large percentage of this type of activity.

### SUMMARY OF THE INVENTION

In one form, the invention is directed to a method of handling a portable article. The method includes the step of delivering the portable article to a destination site at which the portable article is operatively associated with an alarm assembly. The alarm assembly has an armed state and an unarmed state. With the portable article operatively associated with the alarm assembly at the destination site and the alarm assembly in the armed state, the alarm assembly generates an alarm signal in the event an unauthorized activity with respect to the portable article occurs.

In one form, the portable article is operatively associated with the alarm assembly by placing the portable article in proximity to a component of the alarm assembly at the destination site.

In one form, the portable article is operatively associated with the alarm assembly by pairing a component on the portable article with a component at the destination site.

In one form, the portable article is operatively associated with the alarm assembly by attaching at least a part of the alarm assembly to the portable article.

In one form, the portable article is operatively associated with the alarm assembly by attaching at least a part of the alarm assembly to packaging material for the portable article.

In one form, the method further includes the step of changing the alarm assembly from the unarmed state into the armed state with the portable article at the destination site.

In one form, the alarm assembly is changed from the unarmed state into the armed state through an action at the destination site.

In one form, the alarm assembly is changed from the unarmed state into the armed state through an action taken remotely from the destination site.

In one form, the alarm signal is a signal detectable at the destination site.

In one form, the alarm signal is sent to a remote location.

In one form, the unauthorized activity is movement of the portable article.

In one form, the unauthorized activity is movement of the portable article past a detector at or in the vicinity of the destination site.

In one form, the unauthorized activity is movement of the portable article at least a predetermined distance away from the destination site.

In one form, the method further includes the step of changing the alarm assembly from the armed state into the unarmed state with the portable article at the destination site.

In one form, the alarm assembly has a sleep state. The method further includes the step of causing the alarm assembly to change from the armed state into the sleep state at the destination site, whereupon the unauthorized activity causes the alarm assembly to generate the alarm signal.

In one form, the alarm assembly is changed from the armed state into the sleep state upon passage of a predetermined time period after the alarm assembly is changed into the armed state.

In one form, the alarm assembly is changed manually from the armed state into the sleep state.

In one form, the method further includes the step of monitoring the state of the alarm assembly through a wirelessly connected device.

In one form, the method further includes the step of changing the state of the alarm assembly through a wirelessly connected device.

In one form, the method further includes the step of changing the state of the alarm assembly by manually controlling the alarm assembly.

### BRIEF DESCRIPTION OF THE DRAWINGS

FIG. 1 is a schematic representation of a portable article of the type with which the present invention can be practiced;

FIG. 2 is a schematic representation of an alarm assembly, according to the invention, with which the portable article of FIG. 1 can be operatively associated;

FIG. 3 is a schematic representation of cooperating components on the alarm assembly that are usable to cause the portable article to become operatively associated with the alarm assembly;

FIG. 4 is a schematic representation of a signal generator on the alarm assembly which is used to activate a camera in the event of the occurrence of an unauthorized activity with respect to portable articles which the invention is aimed at detecting;

FIG. 5 is a schematic representation of a wired/wireless device that might be used to perform operations associated with the inventive system and its operation;

FIG. 6 is a flow diagram representation of the operating routine for one form of the inventive alarm assembly; and

FIG. 7 is a flow diagram representation of a method of handling a portable article, according to the invention.

### DETAILED DESCRIPTION OF THE PREFERRED EMBODIMENT

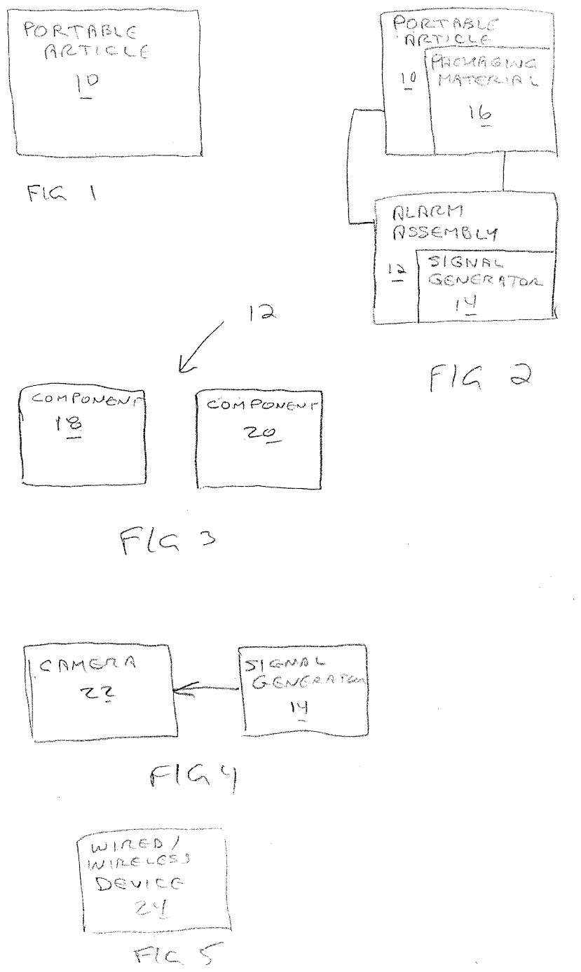

The present invention is directed to the handling of portable articles, as shown schematically at 10 in FIG. 1. The primary objective of the invention is to control theft of articles commonly transported to, and left at the outside of, a building or another drop-off location, at a destination site. “Portable” is intended to encompass articles that can be relatively easily lifted and moved by one or more persons.

The principle focus of the invention is on previously purchased/ordered articles that are delivered, by a purveyor or a shipper authorized by a purveyor, to a site designated by a purchaser. Per the Background discussion above, the focus is on deliveries made whereby articles are placed in plain view and without any structure confining them at respective sites. As just examples, groceries are commonly purchased and delivered to doorsteps of residences and businesses. Virtually all other types of consumables in portable form are capable of being transported to, and dropped off, at locations where the articles are vulnerable, generally by residing at an exterior location where no persons are physically present, or available, to protect against, or observe, theft. Use at any site where there is no, or low, traffic flow or activity is contemplated.

According to the invention, an alarm assembly 12 is utilized. The portable article 10 is in different ways operatively associated with the alarm assembly 12.

The alarm assembly 12 has an armed state and an unarmed state. The alarm assembly 12 further has a signal generator 14.

With the portable article 10 operatively associated with the alarm assembly 12 at a destination site, which may be at a front doorstep, or an interior location designed for accepting deliveries at which it remains visible or otherwise vulnerable, etc., and the alarm assembly in the armed state, the signal generator 14 on the alarm assembly 12 generates an alarm signal in the event an unauthorized activity with respect to the portable article 10 occurs.

The alarm assembly 12 may be directly connected to the portable article 10 or may be connected through packaging material containing, or overlying, the portable article 10. The connection may be a permanent connection, a connection as by using adhesive, or a releasable connection, such as alarm assemblies that are separable as by using dedicated tooling or techniques that limit control and operation thereof to authorized individuals.

The alarm assembly 12 may be a self-contained system at the destination site or one that cooperates with one or more components at the destination site to become operatively associated with the alarm assembly and cause the alarm assembly to be placed in its armed state.

For example, there may be a pairing of components, one each on the portable article 10 and at the destination site, that cooperate to cause the portable article to become operatively associated with the alarm assembly and allow placement of the alarm assembly in the armed state. The pairing may occur as an incident of a component making up part of the alarm assembly being placed in proximity to the component of the alarm assembly at the destination site.

This latter concept is depicted schematically in FIG. 3 by showing the alarm assembly 12 to be made up of cooperating components 18, 20, with one of the components 18, 20 associated with the portable article 10, and the other of the components 18, 20 strategically placed at or near the destination site.

The alarm assembly 12 may be changed from the unarmed state into the armed state with the portable article residing at the destination site.

The action taken to change the state of the alarm assembly may be performed at the destination site, as by a delivery person, or from a location remote from the destination site.

The unauthorized activity that triggers the signal generation may vary significantly. The unauthorized activity may be simply movement of the portable article 10 once the alarm assembly 12 is placed in its armed state.

A triggering movement may be any movement or movement of the portable article 10 past a detector at or in the vicinity of the destination site.

Alternatively, the movement may trigger the alarm signal as an incident of the article being moved a predetermined distance away from the destination site.

The signal from the generator 14 may be an audible signal detectable at the detection site—whether audible and/or visual in nature.

Alternatively, the signal from the generator 14 may be directed to a device at a remote location.

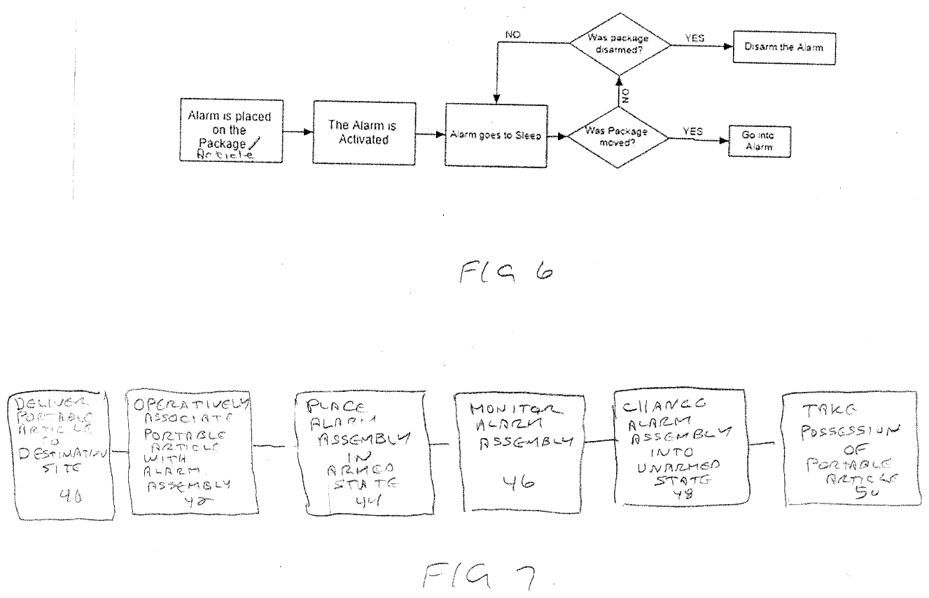

In one form, as shown in FIG. 4, the signal generator 14 may trigger operation of a camera 22, which might be monitored onsite or at a remote location.

Operation of the alarm assembly 12 and monitoring thereof can be effected through any type of existing wired or wireless device, as shown schematically in FIG. 5 at 24. For example, the alarm assembly 12 may be placed in the armed state using a smartphone or tablet. Activation may be effected using Bluetooth, NFC, or any other wireless protocol available or that becomes available.

This wired/wireless communication may be used to perform any function associated with the system, including changing states, monitoring states, etc.

In one form, the alarm assembly 12 additionally has a sleep state which may avoid draining of a power supply for any component of the alarm assembly 12 during operation. The alarm assembly 12 is constructed so that the signal generator 14 will generate a signal in the event the unauthorized activity occurs with the alarm assembly 12 in the sleep state.

The alarm assembly may be placed into the sleep state through manual control or the sleep state might automatically be transitioned to after passage of a predetermined amount of time after the alarm assembly 12 is placed into the armed state.

FIG. 6 is a flow diagram showing the basic operating routine for the inventive alarm assembly 12.

The basic overall inventive system operation is depicted in flow diagram form in FIG. 7.

As shown at block 40, a portable article is delivered to a destination site, typically an exterior location at a home or business, or a minimally secured location, where the portable article will be in plain view or accessible, and effectively unattended.

As shown at block 42, the portable article is operatively associated with the alarm assembly 42 whereby it can be placed in different states.

As shown at block 44, the alarm assembly is placed in the armed state.

As shown at block 46, with the alarm assembly in the armed state, the alarm assembly can be monitored, as to confirm that it is in the armed state and to receive any signal indicative of a breach/occurrence of unauthorized activity.

As shown at block 48, the alarm assembly is changed into the unarmed state by an authorized individual, such as the owner/occupant of the home or business at which the portable article is delivered.

As shown at block 50, once the alarm assembly is placed into the unarmed state, the target recipient, or person acting on his/her behalf, can take possession of the portable article at the destination site.

As noted above, the portable article can be operatively associated with the alarm assembly prior to delivery or upon making the delivery. The state of the alarm assembly may be changed to armed automatically upon the delivery being effected or arming may occur afterwards and may be effected by the delivery person or by the recipient from a remote location.

The foregoing disclosure of specific embodiments is intended to be illustrative of the broad concepts comprehended by the invention.

1. A method of handling a portable article, the method comprising the steps of:
delivering the portable article to a destination site at which the portable article is operatively associated with an alarm assembly,
the alarm assembly having an armed state and an unarmed state,
with the portable article operatively associated with the alarm assembly at the destination site and the alarm assembly in the armed state, the alarm assembly generates an alarm signal in the event an unauthorized activity with respect to the portable article occurs.

2. The method of handling a portable article according to claim 1 wherein the portable article is operatively associated with the alarm assembly by placing the portable article in proximity to a component of the alarm assembly at the destination site.

3. The method of handling a portable article according to claim 1 wherein the portable article is operatively associated with the alarm assembly by pairing a component on the portable article with a component at the destination site.

4. The method of handling a portable article according to claim 1 wherein the portable article is operatively associated with the alarm assembly by attaching at least a part of the alarm assembly to the portable article.

5. The method of handling a portable article according to claim 1 wherein the portable article is operatively associated with the alarm assembly by attaching at least a part of the alarm assembly to packaging material for the portable article.

6. The method of handling a portable article according to claim 1 further comprising the step of changing the alarm assembly from the unarmed state into the armed state with the portable article at the destination site.

7. The method of handling a portable article according to claim 6 wherein the alarm assembly is changed from the unarmed state into the armed state through an action at the destination site.

8. The method of handling a portable article according to claim 6 wherein the alarm assembly is changed from the unarmed state into the armed state through an action taken remotely from the destination site.

9. The method of handling a portable article according to claim 1 wherein the alarm signal is a signal detectable at the destination site.

10. The method of handling a portable article according to claim 1 wherein the alarm signal is sent to a remote location.

11. The method of handling a portable article according to claim 1 wherein the unauthorized activity is movement of the portable article.

12. The method of handling a portable article according to claim 1 wherein the unauthorized activity is movement of the portable article past a detector at or in the vicinity of the destination site.

13. The method of handling a portable article according to claim 1 wherein the unauthorized activity is movement of the portable article at least a predetermined distance away from the destination site.

14. The method of handling a portable article according to claim 1 further comprising the step of changing the alarm assembly from the armed state into the unarmed state with the portable article at the destination site.

15. The method of handling a portable article according to claim 1 wherein the alarm assembly has a sleep state and further comprising the step of causing the alarm assembly to change from the armed state into the sleep state at the destination site, whereupon the unauthorized activity causes the alarm assembly to generate the alarm signal.

16. The method of handling a portable article according to claim 15 wherein the alarm assembly is changed from the armed state into the sleep state upon passage of a predetermined time period after the alarm assembly is changed into the armed state.

17. The method of handling a portable article according to claim 15 wherein the alarm assembly is changed manually from the armed state into the sleep state.

18. The method of handling a portable article according to claim 1 further comprising the step of monitoring the state of the alarm assembly through a wirelessly connected device.

19. The method of handling a portable article according to claim 1 further comprising the step of changing the state of the alarm assembly through a wirelessly connected device.

20. The method of handling a portable article according to claim 1 further comprising the step of changing the state of the alarm assembly by manually controlling the alarm assembly.
